(19) United States
(12) Patent Application Publication
(10) Pub. No.: US 2012/0148045 A1
(43) Pub. Date: Jun. 14, 2012

(54) SYSTEM FOR THE CONTROLLED DATA EXCHANGE BETWEEN AT LEAST TWO DATA CARRIERS VIA MOBILE READ-WRITE MEMORIES

(76) Inventor: Robert Niggl, Bad Reichenhall (DE)

(21) Appl. No.: 12/735,983

(22) PCT Filed: Feb. 21, 2009
(86) PCT No.: PCT/DE2009/000258

§ 371 Date: Aug. 27, 2010

(30) Foreign Application Priority Data
Feb. 29, 2008 (DE) 10 2008 011 882.6

(51) Int. Cl. H04K 1/00

(52) U.S. Cl. 380/270

(57) ABSTRACT

The present invention relates to a data transmission system (1), which it enables a controlled data exchange between at least two data carriers via mobile (location independent) read/write memories, particularly a system for the secure forwarding of individual data to predetermined recipients while controlling those involved. Those involved, or the mobile memories, do not have to be identified/registered in any way with respect to the system, which is to say they can remain completely anonymous. The respective output data, such as a patient file or a fingerprint, are represented as one-time-pad key cipher pairs, and the pair components are always distributed among different mobile and central intermediate storage devices.

The present invention is concerned with a device and a method for controlled data exchange between at least two data carriers through mobile read-write-memories, in particular with a system for receiving and preparing individual data for secure conducting to predetermined receivers.

Such methods and systems are known in the state of the art. The data transported in this way exhibit usually the deficiency to be broken up and to be falsified with suitable means such that they are as a result not sufficiently safe, in particular not safe for the future in view of future computer systems with corresponding capacity (head word: quantum computer). A method for compressing of data amounts at modern encryption methods for example has become known from the patent document WO 2007/109373 A2, to which reference will be made in the following to the respective context.

Therefore it is an object of the present invention to furnish a system, which operates according to a certain method and which is capable of receiving individual data safely, of processing, and of further conducting formatted and safe to or from a predetermined data carrier.

This object is obtained with the characterizing features of the main claims.

According to the present invention the method for controlled data exchange between data carrier systems with mobile (that is location independent) read-write-memories characterized in that a first carrier system (source system) presents arbitrary serial starting data (S) via cryptographic module and one-time-pad-key-cipher-pair and then through integration module externally stores intermediately, wherein always a pair component (K_{—}1) callable—therefore in particular with a systemwide suitable reference—is laid down through data telecommunications DFÜ on a central intermediate memory and wherein the other pair-component (K_{—}2) and the K_{—}1 reference on mobile memories, such that a second carrier system (target system) can obtain initially the OTP-key-cipher-pair and can finally obtain through decoding the starting data itself through connection and evaluation of the mobile memories and by calling of the centrally deposited component.

The carrier system according to the invention is in particular characterized in that it is furnished with an OTP-cryptographic module and

(a) arbitrary serial starting data (S) as a source system are cryptonized in a predetermined shape by OTP-key-cipher-pair (compare below); and
(b) reconstructs starting data as a target system from OTP-key-cipher-pairs.
An OTP-data compression, for example according to patent document WO 2007/109373 A2, is not a precondition. The OTP-crypto unit of a source system randomized therefore generates a one time key E, which has the same length as S and which encrypts S with E through a bit conjunction (cipher V).

The bit addition is recited here as an example for a bit conjunction : 0+1=1+0=1, 1+1=0+0=0.

Then there is V=S+E and S=V+E, wherein in each case bit wise addition is performed. Note to the mathematical literature: the bit addition has the properties of an “abelian group”; therefore one can for example calculate “as with integers”. The bit addition is also known in algebra as “addition in the smallest field (|F_{—}2)”.

The method is shown in FIG. 3.

The starting data cryptonized as key-cipher-pairs are then prepared for the intermediate memory through the integration unit that they can there be readable and/or callable be deposited, wherein always a pair component is centrally deposited by data telecommunication DFÜ and the other pair component is mobile.

After depositing the data, the mobile memory(ies) is(are) transported physically to the target system. They are connected there and are evaluated by the integration unit such that finally the centrally deposited component can be called. The cryptonized starting data are as a result then available to the target system such that starting data (S) can be reconstructed through the crypto unit.

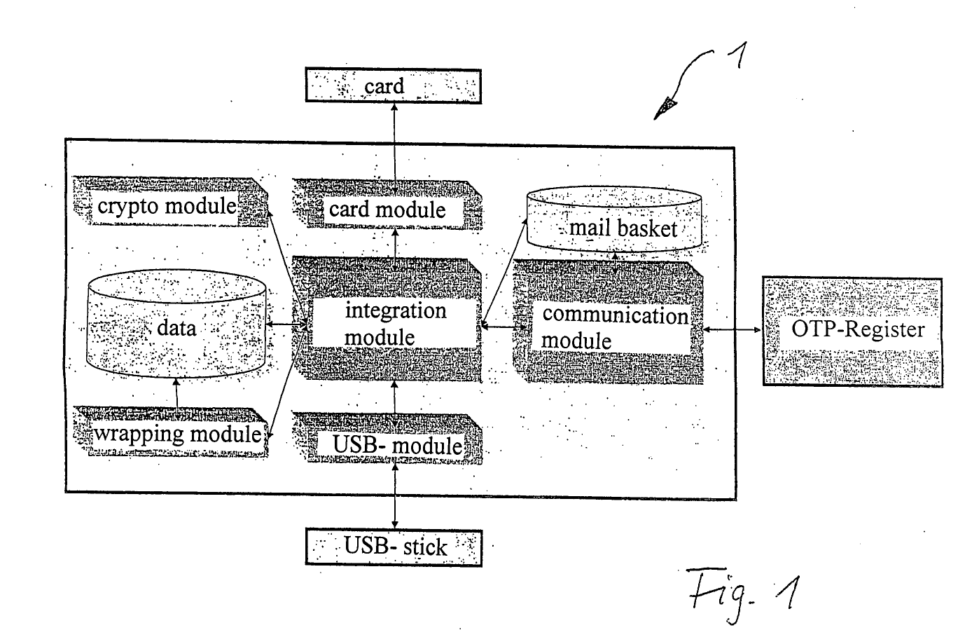

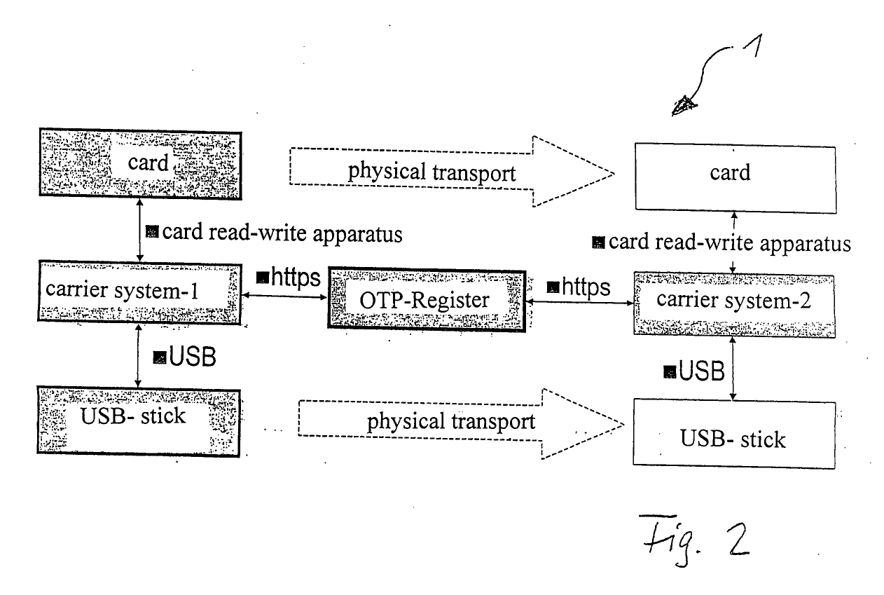

The processes for the secure data transmission are illustrated in the FIG. 1 and FIG. 2.

The cryptonization of arbitrary starting data S in the shape of an OTP-key-cipher-pair stands at the starting point of the technical processes. The transport of the pair component is then performed through mobile and central intermediate storages to the respective target system.

This description of the technical data flow considers a special feature of the OTP-cryptography: apparently holds V+E=E+V, this meaning that the key and the cipher are not distinguishable, since the keys and the ciphers are of the same length, carry no information and are exchangeable.

An extreme example is to clarify that a technical data flow description for OTP-key-cipher-pairs in “classic” concepts would be misleading:

Assuming, the crypto unit of the source system delivers the pair in such a way that it exchanges the components randomly controlled. Then not even the source system would know in which way the key and in which way the cipher is transported.

But even if it would be documented in the source system, what was key and what was cipher, this identification would be an illusion: for a given key-cipher-pair, this claim would not (mathematically secured) be checkable or testable and therewith would be technically irrelevant.

It holds in reverse: each technical data flow description which assumes certain data elements as “key” or, respectively, “cipher”, does not capture OTP-key-cipher-pairs.

The “identity loss” of key and cipher appears on first impression to be “paradox”. In fact there is no information loss present, but instead characteristics of the presented secure method.

Supported by the main theorem of information theory (Shannon) one could even show that each secure method has to exhibit these characteristics.

Thus it is advantageous, that a central intermediate memory is furnished, which is characterized in that a carrier system there according to the method by way of data telecommunication DFU OTP-keys or, respectively, OTP-ciphers are recallably deposited. As mentioned above it would however be misleading to talk about “a key pool” or “a cipher pool”. Instead it is concerned with an OTP-data pool, that is a data pool for components of OTP-key-cipher-pairs.

It is further advantageous to furnish at least one communication module, which communicates with the OTP-data pool.

It is further advantageous (and necessary in case of a corresponding data amount) to furnish at least one mobile mass data memory (for example a USB-stick) for the mobile stored data.
The method according to the invention offers the following advantages:
1. The mobile mass memories are by now inexpensive and can be deployed without problem, this means without additional reinstallation costs.
2. If the central mass memory is used only as OTP-data pool, then no conclusions regarding starting data S are possible with a suitable reference formation (compare proposals below).
3. Furthermore by employing chip cards in combination with mobile mass memories (for example USB-sticks), the mobile data can be distributed such that the mobile deposited pair component K_{—}2 is deposited on a mobile mass memory (“security”) and the reference for the centrally deposited pair component K_{—}1 is on the chip card: the mobile mass memory could then be lost without security risks and the chip card could as usually be used, that is continuously carried on. In addition K_{—}2 can additionally be encrypted with a card key (compare an example set forth below).

It is also being mentioned that the invention can be employed for the biometrical identification of persons in such a way which avoids the misuse of the identification data. In this situation S are then biometrical informations, which are obtained by the source system from a corresponding reader (for example a fingerprint scanner). The source system holds S only temporarily, that is it erases or extinguishes the cryptonized data again after the depositing. The same holds for the target system: the target system reconstructs S over the cryptonized data, compares S with input data and then extinguishes both S as well as comparison data. As a result, therewith the critical data are available always only locally and temporarily and nevertheless the system allows the biometrical identification without doubt.

These not foreseeable advantages, compared to the situation of the methods and systems known in the state-of-the-art, render the present invention in addition also safe for the future.

The invention is described in more detail in the following by way of drawings.

There is shown in

FIG. 1: a block diagram of the cooperation of the various modules in the data carrier system according to the invention (1);

FIG. 2: a block circuit diagram of the data carrier system (1) with associated different technical devices.

FIG. 3: a method for a computer supported randomized generation of long keys.

The FIG. 1 shows a block diagram of the connections of the various modules in the data transfer system 1 according to the present invention. Starting with (IT-) systems, which store data referring to persons or, respectively, proprietors, an integration system is presented, which enables the secure, in particular falsification secured, exchange of these data between the starting systems such that the concerned persons retain the final control over the data exchange.

The proprietors of the starting systems are designated in the following as carriers, and their IT-systems are designated as carrier systems.

The proprietors of the data referring to persons are designated as “the concerned”.

A possible field of application for the solution is the health maintenance field (headword: electronic health card/eHC). There the medical providers are the carriers, carrier systems are IT-systems of these medical providers (in case of a physician for example the physician software with the associated hardware). The concerned are patients or, respectively, insured.

We require the pre-condition in the following that each carrier or, respectively, each carrier system is suitably identified systemwide. Sensibly, the identification is maintained persistent over time, for example by a general sequential and continuing numbering such that a number is given out only once over the time.

The identification of the carrier systems or, respectively, of the carriers is constitutive for limiting of the overall system (ensemble identification) and therefore important. An identification/registration of the mobile memories or, respectively, of the concerned is not presupposed. It is a particular advantage of the invention that these can remain completely anonymous.

The new overall system is generated by expanding an ensemble of carrier systems around central memories and not location bound (portable) memories referring to persons for concerned, as well as a logic, which networks all memories together.

Concerned, who want to participate at the system, are equipped with the following memory elements for this purpose, wherein the associated readers/interfaces are also recited:

one or several writeable chip cards with usual card reading writing apparatus, in short called card apparatus, as an interface.
one or several portable mass memories with USB-interface, in the following called USB-sticks, wherein the USB-technology here stands as an example for a data memory access technology. Other portable mass memory solutions with sufficient distribution are also conceivable.

The use of at least one mobile mass memory for each concerned is constitutive with corresponding data volume, that is a minimum precondition. The use of a writable or recordable card is recommended.

A further central memory system completes the infrastructure:

a central memory (in the following called OTP-register) with Internet interface or, respectively, analog interfaces for the remote data access, wherein the central memory is accessed in an authorized way over mobile corresponding protocols such as for example https; also solutions are captured which furnish several central OTP-registers from the point of view of the carrier systems; we assume for this case that these several central OTP-registers are identifiable through unique registration numbers.

These new technical elements and the carrier systems are integrated through a logic, which can be realized for example through software components and which are designated as modules in the following.

The logic is described through corresponding function groups. The group formation is apparent, but not necessary.

The control unit, which the represents the logic on a carrier system, is in this sense supported on further functional units and is designated in the following as integration module.

The integration module is supported by the following additional functional groups:

the communication module communicates with the central OTP-register
the cryptographic module contains the encryption technology inclusive random number generator
the packaging or wrapping module serializes/deserializes data
the card module generates/interprets the card data, that is the card module repairs in particular the data read out such that the following disposed systems can process/present the data
the USB-module generates/interprets data on the USB-sticks.

The communication module, the cryptographic module, the USB module perform the same functions on all carrier systems. Therefore they are portable, which means not bond to a location, implementable into the system (for example as SW module).

The packaging or wrapping modules are in their input naturally specific to a carrier system, for example specific for a physician software.

The card modules are naturally uniform in the core of their interfaces (card module core). Possibly further interfaces specific to a carrier system are useful however for the integration of such a core in a carrier system.

The in the following described realization of the system according to the present invention by way of example is based on chip cards and USB-sticks. It is started with a refined view of the data of the card in order to enable a comparison close to reality of an electronic health card eHC solution.

The card contains
a key for the AES method (advanced-encryption-standard) randomized generated on the cryptographic module within the framework of the decentralized initialization, in the following called card key; AES stands here by way of example for a symmetrical ciphering method.
arbitrary base data about the concerned, for example indications to the identification of persons, blood group, insurance numbers are designated in the following as base data;
metadata over the USB-stick(s), which in the following are designated as stick register.

Base data are not constitutive, this means it is also conceivable in an extreme case that no foundation data referring to the concerned are used.

Metadata are not constitutive, however they are very sensible. For example, the number and size of the USB-objects would be a sensible meta-information or refined context informations for the respective serialization, inclusive control values.

The AES-key is not constitutive, that is it can be dispensed with. However it is recommended.

Important: a card and its associated USB-sticks is administered by the concerned in each case, the central memory(ies) is/are administered by one or several central administrative units, and carrier systems are administered as up to now by their carrier.

The generated overall system furnishes that the data can secure and in particular secure against falsification and under the control of the concerned, be transferred from a carrier system A to a carrier system B, for example a patient file from a specialized physician to a family physician. The carrier source system, that is the carrier system on which the data are generated for the first time, prepares the data exchange as follows for a given serializable data object D (virtualization of the data object):

1. D is correspondingly serialized by the packaging module, that is transformed into a corresponding byte sequence (in the following called memory object).
2. The integration module numbers the memory object S with a continuing number, or, respectively, alternatively with the unique random number and is called local object number in the following, such that the tuple (local object number, carrier number, carrier system system number, OTP-registration number) is a unique reference for the memory object S systemwide.
3. The memory object S is presented as an OTP-key-cipher-pair (K_{—}1, K_{—}2) by the OTP-cryptographic module, wherein K_{—}1=key or, respectively, cipher and K_{—}2=cipher or, respectively, key.
4. In the following K_{—}2 is additionally encrypted (result: K_{—}2′) by the cryptographic module with the card key in a second ciphering. This ciphering is not constitutive, that is it is only recommended.
5. The pair component K_{—}1 is now together with the S reference transferred through the communication module to the central OTP-register according to the OTP-registration number.
6. The (additionally encrypted) pair component K_{—}2′ is copied onto the USB-stick as a binary file (personalization 1).
7. The stick register is actualized; possibly associated administrative information are in the same way actualized on the card or on the USB-stick (personalization 2)
8. Result: the data object D is thereby virtualized, that is the cryptonized data (K_{—}1, K_{—}2) are deposited outside of the source system according to the method.

The virtualization of the data D was presented on the base of an initialized card with card key, and the like. If the card is not initialized, then the course is only to be supplemented by a further initialization step, which initialization step runs also in the carrier source system supported by the card module (generation of the card key, loading of the base data, and so on).

The solution does not require therefore any central initialization.

The concerned could—depending on desire—employ one or several USB-sticks as long as the stick register is conceived sufficiently flexible.

It is reversely proceeded in the carrier system of another carrier, called in the following carrier target system for transferring the memory object S:

1. (Data connection) The concerned leads his or her card and the associated (or, respectively, an associated) USB-stick into a corresponding reader apparatus in the target surroundings.
2. (Selection process) The carrier or, respectively, a substitute operator determines a virtual memory object S through the card module over the stick register. The S-reference of the virtual memory object S and the encrypted K_{—}2′ is then copied from the USB-stick onto the carrier system (inclusive card key).
Recommendation: sensibly, this selection process is supported by corresponding systems; it could then be assured through metainformation on the card or, respectively, on the USB-stick, that this selection is correspondingly limited. In the case of medical providers for example over the special field of activity.
3. It is authorized accessed through the communication module via reference to the central memory and the complementary pair component K_{—}1 is called (central component access).
4. Initially the encrypted K_{—}2′ is decoded with the card key through the cryptographic module and in the following the starting data S are reconstructed (decoding) from the cryptonized output data K_{—}1, K_{—}2 through the cryptographic module.
5. S is disposed on the target system as a result.

An embodiment example of the present invention shown in FIG. 2 as a recommended embodiment example:

the USB-input and the card input are secured and separate channels in the carrier system, wherein the channels lead into a (secured) core region.
the path to this core region is performed with an additional, case referred cipher.
each access is recorded in the central memory such that it can be determined during a revision of a carrier system if only permissible information was downloaded.

Therefore, the invention allows the secured and authentic (secured against falsification and forgery) exchange of data relating to a person without that the concerned themselves have to be identified in the system in any way. The cryptonized data K_{—}1 or, respectively, K_{—}2 are further no data in the classic sense: they do not carry any information. The solution is therefore safe for the future, and therefore does not have to fear the quantum computer.

The bit addition is shortly described for purposes of completeness and the properties relevant for ciphering are proven. A “notation close to programming” is employed. The ̂ mark is employed instead of the + mark for the corresponding bit operator, is available in many programming languages.

Definition: be !0=1, !1=0 (negation)

apparently then holds !!x=x
Definition: Be 0̂0=1̂1=0 and 0̂1=1̂0=1 (bit addition or, respectively, XOR conjunction)
Then always holds

x̂x=0 (clear)

x̂!x=1 (clear)

x̂0=x (since 1̂0=1, 0̂0=0)

x̂1=!x (since 1̂1=0, 0̂1=1)

Furthermore it holds always for the variables x, y

x̂y=ŷx (clear)

We consider now arbitrary bit variables x, y, z and show:

x̂(ŷz)=(x̂y)̂z

Assumption: y=z.

The right hand side then delivers

x̂(ŷz)=x̂0=x

there are two cases possible for the left hand side:

(x̂x)̂x=0̂x=x

(x̂!x)̂!x=1̂!x=!!x=x

Assumption: y≠z
The following cases are then possible for the left hand side:

x̂(x̂!x)=x̂1=!x

x̂(!x̂x)=x̂1=!x

the following cases are then possible for the right hand side:

(x̂!x)̂x=1̂x=!x

(x̂x)̂!x=0̂!x=!x

Consequently the equation holds in all cases.
S be a bit list as up to now, E an equally long one time key, and the cipher V is defined as V=ŜE, wherein the addition is performed by components. If then O is an equally long bit list with only zeros then holds V̂E=(ŜE)̂E=Ŝ(ÊE)=ŜO=S.
Concluding the randomization method according to FIG. 3 be described in its central aspects:

A long bit list is generated “piecemeal” with a standard random number generator, wherein the random number generator is reinitialized after each step with securely ciphered storage values. The determination of the stick length and the selection of the storage values is also performed randomized. If the sticks are “short enough” and if the value store is “large enough” and “unpredictably enough”, then a sequence of independent random number experiments is simulated as a result. Securely ciphered values are apparently ideal reinitialization values such that independence is inherited in a certain way “step-by-step”. Therefore, the method delivers randomized bit lists of high quality under the recited preconditions. Suitable storage values can be obtained with computer support (compare FIG. 3). The amount of possible results would be so large with such a value storage that the amount of possible results could not any longer be simulated externally.

### Randomized Generation of Long Bit Lists

### 1 Summary

This document which describes a method for generating arbitrary long randomized bit lists based on random number generators for the lists with delimited bit number.
The strategy comprises to establish a corresponding vector B=(B₁, . . . , Bₙ) from sufficiently short partial lists Bᵢ, which partial lists are obtained by independent reinitialization and in fact the reinitialization process is controlled through a variable number of parameters (calling storage values).
It is shown that under certain conditions—in particular with regard to the number and the obtaining of the storage values—the total list is sufficiently well randomized.

### 2 Basic Concepts, Notations

Definition 1. An (elementary) random number generator Z described in the following as a tuple (f, g, m) with

f is an initialization function

g is a production function which delivers m bits

For a random number generator Z=(f, g, m) be

Init(Z):=f(pronounce: initialization function of Z)

Prod(Z):=g(pronounce: production function of Z)$

Bitnumber(Z):=m (pronounce: bit number of Z)

Inits(Z):=number of parameters of Init(Z)

Definition 2. If Z is a random number generator, then Byte(Z) be the following function:

entry: a number h

output: h Byte which are generated by repeated call of Prod(Z), that is Prod(Z) is x-times, Bitnumber(Z)*x>h*8, successively called up, the generated bits are chained and then (the first) h byte are given out.

Definition 3. For a list a=(a₁, . . . ,aₘ) be |a|:=m the length of the list. If a=(a₁, . . . ,aₘ), b=(b₁, . . . ,bₙ) are lists, then be ab:=(a₁, . . . ,aₘ, b₁, . . . ,bₙ) that list results by chaining of a with b. If X=(X₁, . . . ,X_{M}) is a list of lists, then be Liste(X) the chaining of all elements.

Liste(X):=X₁ for M=1

Liste(X):=Liste((X1, . . . ,XM−1))XM for M>1

Definition 4. For a data object x be in the following dim(x) the memory requirements of x in byte.

### 3 Placement of Task

A byte list of the (minimum) length M is to be generated with a random number generator Z.

### 4 Solution

### 4.1 Overview

A vector B=(B₁, . . . ,Bₙ)n>0 of byte lists Bᵢ is generated step-by-step through Z, wherein the byte lists give overall a sufficient long total list, that means

|Liste((B₁, . . . ,Bₙ₋₁))|<M≦|Liste(B)|

wherein prior to each step the initialization function of Z is called.

at the first step (i=1) classic initialization values are employed (for example actual time stamps).

in each step i, the reinitialization parameters are determined for the next step (I+1) such that a corresponding selection of values Vⱼ is randomly performed out of a value storage V=(V₁, . . . ,V_{H}) and the parameters are then One Time Pad encrypted, wherein the keys are in each case newly generated through Byte(Z).

furthermore the length of Bᵢ is determined randomized in the step i within adjustable limits—a minimum length (L) or, respectively, a maximum length (L′).

### 4.2 Algorithms

1: procedure randomize (Z,B,M,L,L′,V)
2: // calculates B with |Liste(B)| >M through Z under the following preconditions:
3: // M > 0
4: // 0 < L ≦ L′
5: // |V| > 0
6: // instructions x := Byte(Z) (dim (x)) set as a precondition an x-type in the following,
7: // which can be covered with arbitrary bits (for example unsigned int)
8: B initialize // now holds: B = (B₁,.....,Bₙ), n =0 that means |B| = 0, |Liste(B)| = 0
9: Auxiliary vector W,|W| = Inits(Z), to cover with standard initialization values
10: for |Liste(B)|< M do // step: B=(B₁,.....,Bₙ) expand by one element
11: Init(Z) call up with W // initialization of Z
12: for k = 1, Inits(Z) do // Wₖ cover for the reinitialization
13: r := Byte(Z)(dim(r)) //determine random number r
14: h := mod(r,}|V|) // determine storage index h
15: S := Byte(Z)(dim(Vₕ)) // determine key S
16: Wₖ := XOR(Vₕ,S) // Vₕ OTP-encipher
17: r := Byte(z)(dim(r)) // determine a further random number r
18: d := max(L, mod(r,L′)) // fix the length d of the new element
19: b := Byte(Z)(d) // calculate Byteliste b of the length d
20: B := (B₁, ....,Bₙ,b) // expand B by b
21: // now holds: |B| > 0, |Liste(B)| > M

### 4.3 Evaluation

### Assumptions:

1. The partial lists are short enough (to be controlled through L, L′).
2. The number of the storage values is not enough (for example |V|=10000).
3. The storage values are generated on the computer caused by system technology and without connection with any field data such that they are not predictable from the outside.
Under these preconditions B is then sufficiently well randomized:

the first partial list is obtained by classic initialization and is therefore sufficiently well randomized.

in each foregoing step, the random number generator is reinitialized with values, which are sufficiently well randomized, therefore each partial list of a sensitive step is sufficiently well and independent randomized since:

If the selected storage values are securely enciphered, then the selected storage values are also in the step i+1 securely and independently enciphered.

it is practically not possible to simulate the amount of possible results over the amount of possible input values.

### 5 Storage Determination

implemented:

collection of addresses of allocated objects in a vector.

the maximum vector length has been reached, then the oldest entries are overwritten, that is a writing position is led, which is set again to 1 after reaching of the maximum length.

1. A method for controlled data exchange between data carrier systems by way of mobile (not bound to a location) read-write memory storage, characterized in that a first carrier system (source system) presents arbitrary serial starting data (S) as one-time-pad-key-cipher-pair through a cryptographic module, wherein the pair components do not have to be identified as key or, respectively, cipher and are then externally intermediately stored, wherein always a pair component (K_{—}1) with reference suitable systemwide is recallable deposited on the central intermediate storage (OTP-data pool) through remote data transmission (RDT) and wherein the other pair component (K_{—}2) and the K_{—}1-reference is deposited on mobile memories, such that a second carrier system (target system) initially can obtain the OTP-key-cipher-pair and finally can obtain the starting data themselves by decoding through connections and evaluation of the mobile memories and by calling the centrally deposited component.

2. The method according to claim 1 further comprising
controlling data exchange between data carrier systems;
furnishing the carrier system (1) with an OTP-crypto module and
cryptonizing arbitrary serial starting data (S) in the shape of OTP-key-cipher-pairs or, respectively,
reconstructing starting data out of OTP-key-cipher-pairs.

3. The method according to claim 1 further comprising
callably depositing or, respectively, calling OTP-keys or, respectively, OTP-ciphers with a carrier system according to the method by remote data transmission (RDT).

4. The method according to claim 1 further comprising
storing or, respectively, reading out OTP-keys or, respectively, OTP-ciphers with a carrier system.
